(19) United States
(12) Patent Application Publication
(10) Pub. No.: US 2013/0019537 A1
(43) Pub. Date: Jan. 24, 2013

(54) End Cap for a Bracket

(71) Applicant: John R. Falcone, Hoboken, NJ (US)

(72) Inventor: John R. Falcone, Hoboken, NJ (US)

(21) Appl. No.: 13/187,691

(22) Filed: Jul. 21, 2011

(51) Int. Cl. E06B 5/00

(52) U.S. Cl. 49/463

(57) ABSTRACT

An end cap for a member is disclosed comprising a base having an upper surface and a lower surface. A first receiving sleeve depends from the lower surface of the base and has a hole therethrough. A second receiving sleeve depends from the lower surface of the base and also has a hole therethrough.

### BACKGROUND OF THE INVENTION

1. Field of the Invention

The present invention generally relates to a protective cover for the end of a bracket. Specifically, the present invention relates to an end cap for a construction member often referred to as angle iron. In particular, this invention relates to an end cap for protecting the end of a length of a bracket, typically having an L-shaped cross-section. By having and using such a protective end cap, the transportation of and construction using such a bracket can be achieved with heretofore unrealized results.

2. Description of the Related Art

Brackets are widely used in the field of construction. They are often transported in bulk and can be cumbersome and unwieldly to handle. Most often made of steel, they can be both heavy and awkward to situate safely. When used at a construction site, such steel members can often become dangerous to the workers when they are either being transported or when they are being used either upright or horizontally because at least one end is exposed. The exposed ends can be hazardous to the workers because they are often sharp, causing cuts and bruises if bumped, scraped with, or impaled upon. There is therefore a great need in the art for a way to protect the workers from the sharp, exposed ends of such brackets.

Accordingly, there is now provided with this invention an improved end cap effectively overcoming the aforementioned difficulties and longstanding problems inherent in the field of construction. These problems have been solved in a simple, convenient, and highly effective way by which to cap the ends of the brackets during either storage, transport, or use.

### SUMMARY OF THE INVENTION

According to one aspect of the invention, an end cap for a member is disclosed, comprising a base having an upper surface, a lower surface. A first receiving sleeve depends from the lower surface of the base and has a hole therethrough. A second receiving sleeve depends from the lower surface of the base and also has a hole therethrough.

According to another aspect of the invention, an end cap for a member is disclosed comprising a base having an upper surface, a lower surface, and chamfered edges around the edges thereof. A receiving sleeve depends from the lower surface of the base, having two arms forming a substantially right angle. The base has two holes, each of which is substantially aligned with each of the arms of the receiving sleeves.

According to yet another aspect of the invention, an end cap for a member is disclosed comprising a substantially triangular base and an L-shaped member depending from the base, having an L-shaped hollow therein. The base has a first hole therethrough connected with one leg of the L-shaped hollow and a second hole therethrough connected with the other leg of the L-shaped hollow.

According to a still further aspect of the invention, an end cap for a member is disclosed, comprising a base having an upper surface, a lower surface. A first receiving sleeve depends from the lower surface of the base and has an aperture therethrough. A second receiving sleeve depends from the lower surface of the base and also has an aperture therethrough.

The method and apparatus of the present invention will be better understood by reference to the following detailed discussion of specific embodiments and the attached figures which illustrate and exemplify such embodiments.

### DESCRIPTION OF THE DRAWINGS

A specific embodiment of the present invention will be described with reference to the following drawings, wherein:

FIG. 1 is an orthogonal top view of the end cap of the present invention.

FIG. 2 is an orthogonal bottom view of the end cap of the present invention.

FIG. 3 is an orthogonal side view of the end cap of the present invention.

FIG. 4 is a bottom view of the end cap of the present invention.

FIG. 5 is a top view of the end cap of the present invention.

FIG. 6 is a side view of the end cap of the present invention installed on a member with a line extended through one of the holes.

FIG. 7 is an enlarged view of FIG. 6.

FIG. 8 is a cut-away top view of FIG. 7.

FIG. 9 is an orthogonal top view of the end cap of another embodiment of the present invention.

### DESCRIPTION OF THE PREFERRED EMBODIMENT

The following preferred embodiment as exemplified by the drawings is illustrative of the invention and is not intended to limit the invention as encompassed by the claims of this application. An end cap 1 for a bracket or a member, for example, a steel member is disclosed herein.

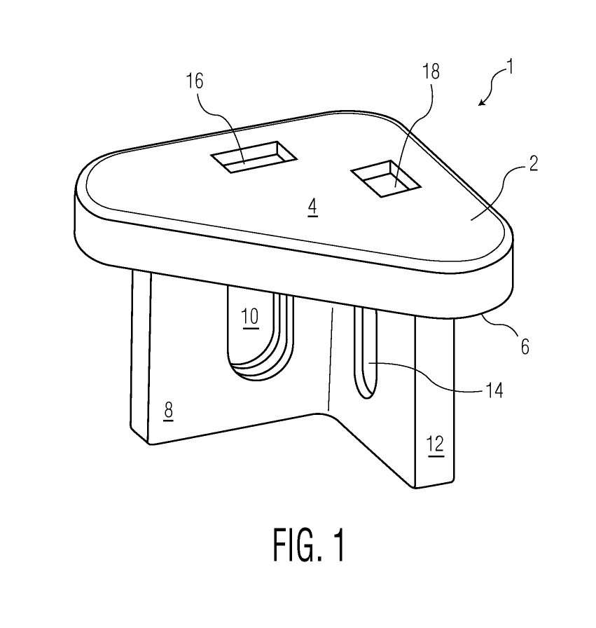

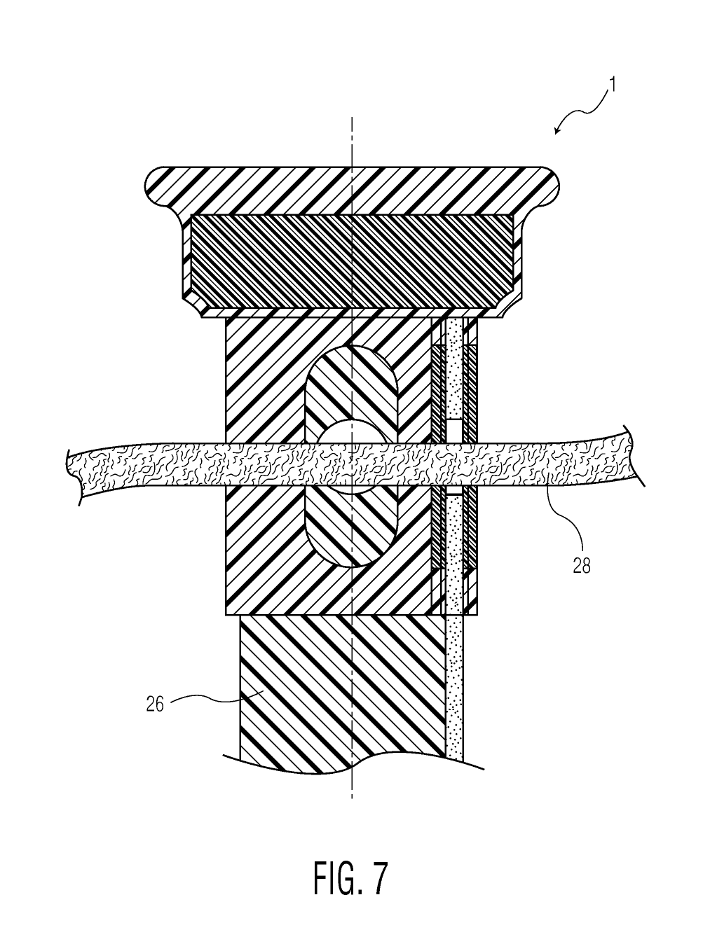

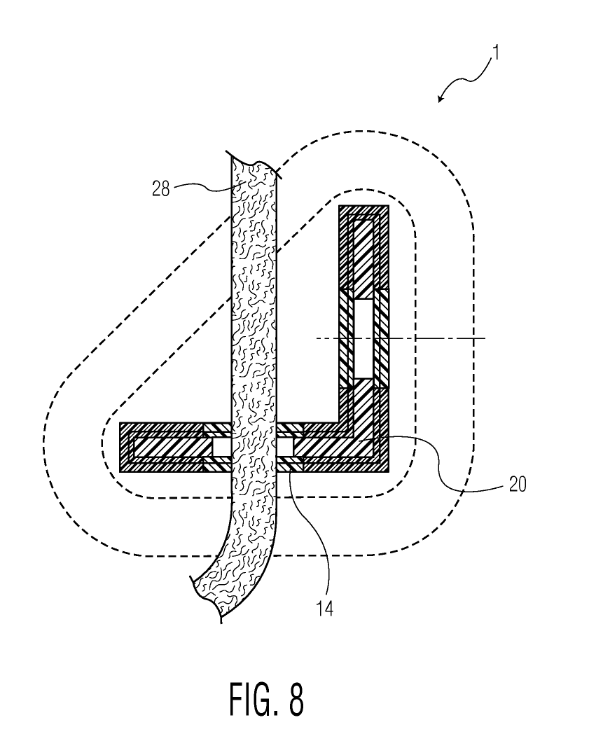

The end cap 1 of the present invention, is illustrated generally in FIGS. 1-9. The end cap is typically made of molded or formed plastic, but may be made alternatively of any number of materials known to those skilled in the art, for example, steel, aluminum, or rubber.

The end cap 1 has a base 2. The base may be generally triangular in shape. The triangular shape may be isosceles or it may be an equilateral triangle. Preferably, the triangle has a right angle so as to match the right angle profile of the bracket to which it is often attached. Of course, if the cross-sectional end of the bracket has a different cross-sectional profile, then the end cap should have the substantially same profile of the bracket to which it is attached. Any portion of the base may be chamfered or rounded over so as to avoid having sharp edges. The base may have chamfered edges around its periphery.

The base 2 has an upper surface 4 and a lower surface 6. A first receiving sleeve 8 depends from the lower surface 6 of the base 2. The first receiving sleeve 8 has a hole 10 therethrough. A second receiving sleeve 12 also depends from the lower surface of the base and also has a hole 14 therethrough. The first and second receiving sleeves are at substantially right angles to each other forming an ‘L’ shape. Further, the first and second receiving sleeves are each substantially parallel with the respective legs of the triangular base. The first and second receiving sleeves may be formed individually and separate from each other positioned in an ‘L’ shape at a substantially right angles to each other or, alternatively, may be connected with each other in an ‘L’ shape at a substantially right angle. Of course, if the bracket to which the end cap is attached has a different cross-sectional profile, then a receiving sleeve of the end cap should be formed so as to receive the end of the bracket to which it is attached.

The hole 10 of the first receiving sleeve and the hole 14 of the second receiving sleeve may be substantially rectangular. Alternatively, one or both ends of each of the holes may be rounded so as to form oval holes or holes with one oval shaped end.

The base 2 has a first hole 16 which is aligned with the first receiving sleeve 8. The first hole 16 may be rectangular in shape or it may be round or oval. The base 2 also has a second hole 18 which is aligned with the second receiving sleeve 12. The second hole 18 may also be rectangular in shape or it may be round or oval.

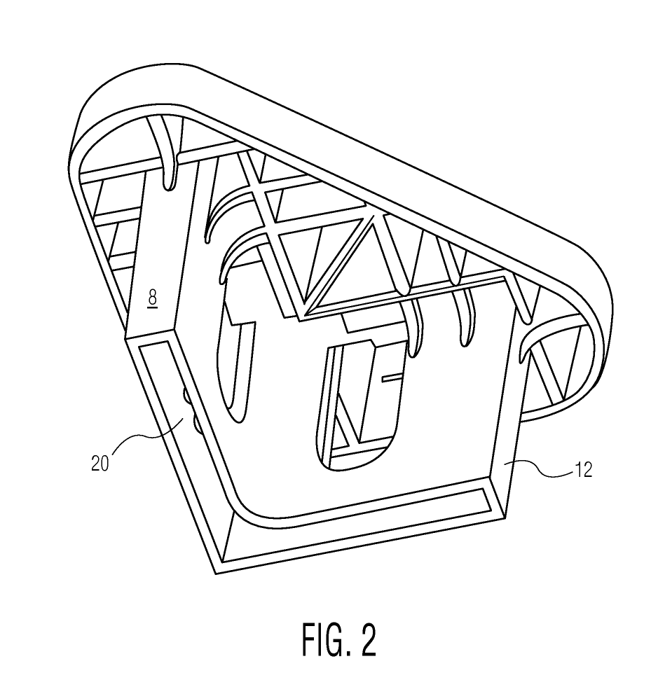

As shown in the orthogonal bottom view of FIG. 2, the first and second receiving sleeves each have a channel 20 therein. The channel 20 may be connected between the two sleeves so as to form a single continuous substantially right angled channel, or alternatively, two separated channels at substantially right angles to each other. The channel 20 is adapted for receiving a right angled longitudinal member, typically used in construction. The right angled member is typically steel, although may be of any number of materials, as is well known in the field of construction. Of course, if the bracket to which the end cap is attached has a different cross-sectional profile, then a channel of a receiving sleeve of the end cap should be formed so as to receive the end of the bracket to which it is attached.

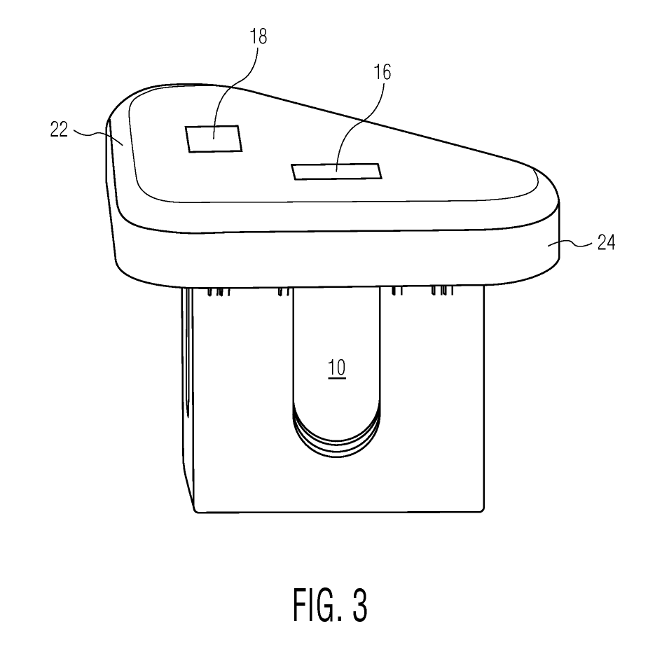

FIG. 3 illustrates an orthogonal side view of the end cap of the present invention. As shown, the bottom portion of the holes of the receiving sleeves are oval shaped. The hole 16 of the base 2 is aligned with the hole 10 of the first receiving sleeve 8. Similarly, the hole 18 is aligned with the hole 14 of the second receiving sleeve 12. The periphery of the top surface of the base is chamfered 22 and the lower surface of the base is at a right angle. Further, the three triangular angles 24 of the base are also rounded over.

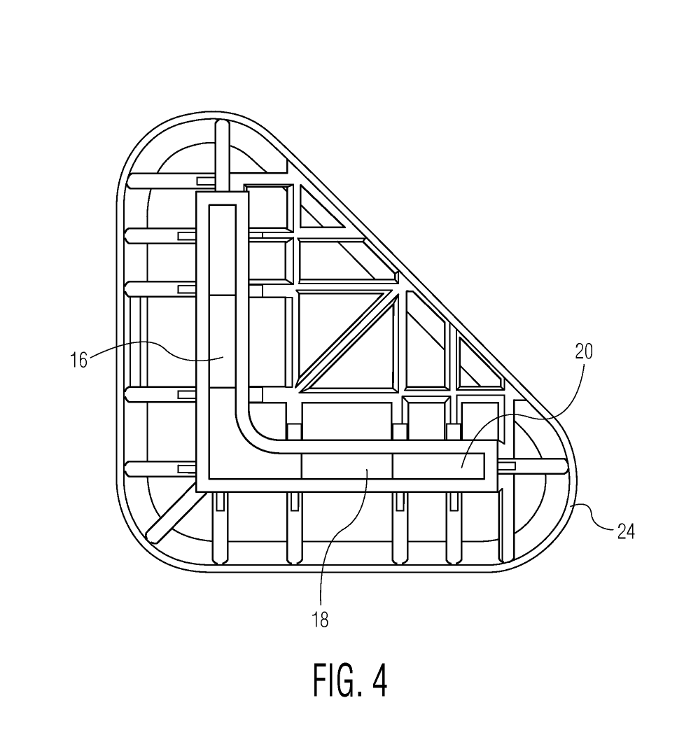

FIG. 4 illustrates a bottom view of the end cap of the present invention showing more particularly the alignment of the holes 16 and 18 of the base with both the holes 10 and 14 of the receiving sleeves and the channel 20 of the receiving sleeves.

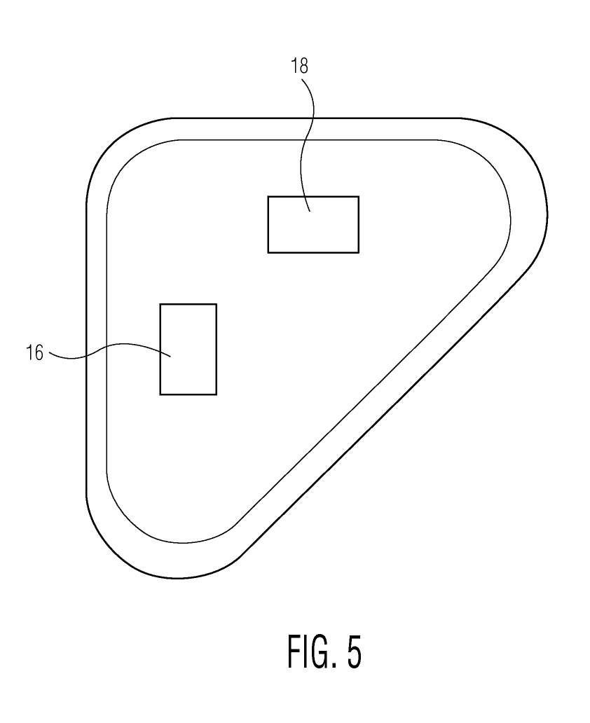

FIG. 5 shows a top view of the end cap of the present invention illustrating the orientation of the holes 16 and 18 of the base. The holes 16 and 18 of the base 2 are preferably rectangular in shape with the major sides of the rectangular holes substantially aligned with the legs of the base. FIG. 5 also illustrates the chamfering of the periphery of the top surface of the base.

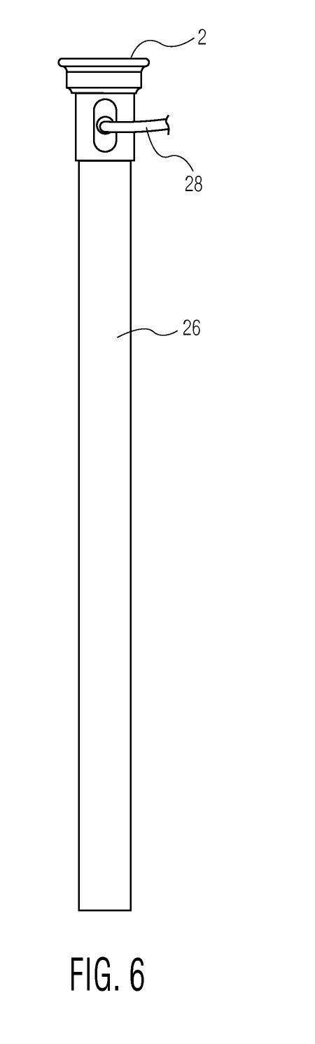

The end cap of the present invention is shown in use in FIG. 6. FIG. 6 is a side view of the end cap of the present invention installed on a member 26. The member 26 which fits into the receiving sleeves of the end cap is typically referred to as “angle iron” and typically has a substantially right angle along its longitudinal axis. Typically, also along the longitudinal axis of the angle iron are a series of spaced holes. The receiving sleeves of the end cap are formed so as to fit securely on at least one of the ends of the angle iron.

Often, the angle iron is used as a vertical post implanted at intervals for creating a type of barrier. Material in conjunction with, or alternatively a rope or line 28 may be extended between the upright members for forming such a barrier. FIGS. 6 through 8 depict an end cap having a line extended through one of the holes of the end cap and threaded through one of the holes of the member. By having a line extended through both the holes of the end cap and the holes of the angle iron, the end cap will be secured to the angle iron and be able to be part of a barrier often created at work sites. Further, the exposed end of the angle iron used as a vertical post is now covered with a protective end cap thus preventing scraping or impalement.

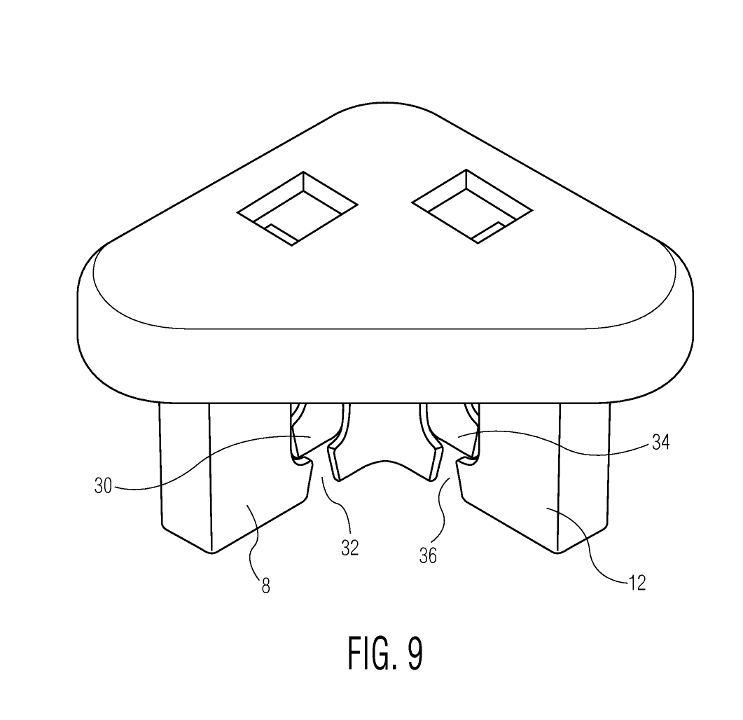

FIG. 9 is an orthogonal top view of the end cap of another embodiment of the present invention. In this embodiment the first receiving sleeve 8 has an aperture 30. The aperture 30 has an opening 32 at its bottom. Similarly, the second receiving sleeve 12 has an aperture 34. The aperture 34 also has an opening 36 at its bottom. By having such openings 32 and 36 at the bottom of the apertures 30 and 34 respectively, the end caps may be more easily placed atop the angle iron after a line has already been threaded through the holes of the angle iron.

Although the particular embodiments shown and described above will prove to be useful in many applications in the construction arts to which the present invention pertains, further modifications of the present invention will occur to persons skilled in the art. All such modifications are deemed to be within the scope and spirit of the present invention as defined by the appended claims.

What is claimed is:

1. An end cap for a member, comprising:
a. a base having an upper surface and a lower surface;
b. a first receiving sleeve depending from said lower surface of said base, wherein said first receiving sleeve has a hole therethrough; and
c. a second receiving sleeve depending from said lower surface of said base, wherein said second receiving sleeve has a hole therethrough.

2. The end cap of claim 1, wherein said base has a first hole substantially aligned with said first receiving sleeve and a second hole substantially aligned with said second receiving sleeve.

3. The end cap of claim 1, wherein said base is a substantially right triangle having two substantially equal length legs and a hypotenuse.

4. The end cap of claim 2, wherein said base has chamfered edges therearound.

5. The end cap of claim 4, wherein said first receiving sleeve and said second receiving sleeve are substantially parallel with the legs of the right triangle.

6. The end cap of claim 2, wherein said first receiving sleeve and said second receiving sleeve have a channel connecting said first receiving sleeve and said second receiving sleeve with each other.

7. The end cap of claim 6, wherein said first receiving sleeve and said second receiving sleeve are at a substantially right angle to each other.

8. The end cap of claim 7, wherein said first hole and said second hole are substantially rectangular.

9. The end cap of claim 8, wherein each of said holes of said first receiving sleeve and said second receiving sleeve have an oval-shaped end.

10. An end cap for a member, comprising:
a. a base having an upper surface, a lower surface, and chamfered edges around the edges thereof, and
b. a receiving sleeve depending from said lower surface of said base, having two arms forming a substantially right angle;
wherein said base has two holes, wherein each of said holes is substantially aligned with each of said arms of said receiving sleeves.

11. The end cap of claim 10, wherein said base is substantially triangular.

12. The end cap of claim 11, wherein said triangle has a substantially right angle and has two substantially equal length legs and a hypotenuse.

13. The end cap of claim 12, wherein each of said arms of said receiving sleeves are substantially parallel with each of the legs of the triangle.

14. The end cap of claim 13, wherein said holes of said base are substantially rectangular.

15. The end cap of claim 14, wherein each of said arms of said receiving sleeve have holes therethrough.

16. The end cap of claim 15, wherein said holes of said receiving sleeve have an oval-shaped end.

17. An end cap, comprising:
a. a substantially triangular base; and
b. an L-shaped member depending from said base, having an L-shaped hollow therein;
wherein said base has a first hole therethrough connected with one leg of said L-shaped hollow and a second hole therethrough connected with the other leg of said L-shaped hollow.

18. The end cap of claim 17, wherein each leg of said L-shaped member has a hole extended therethrough.

19. The end cap of claim 18, wherein said hole through each leg of said L-shaped member has a rounded end.

20. The end cap of claim 19, wherein said base has chamfered edges therearound.

21. An end cap for a member, comprising:
a. a base having an upper surface and a lower surface;
b. a first receiving sleeve depending from said lower surface of said base, wherein said first receiving sleeve has an aperture therethrough, wherein said first aperture has an opening in said first receiving sleeve; and
c. a second receiving sleeve depending from said lower surface of said base, wherein said second receiving sleeve has an aperture therethrough, wherein said second aperture has an opening in said second receiving sleeve.

22. The end cap of claim 21, wherein said base has a first hole substantially aligned with said first receiving sleeve and a second hole substantially aligned with said second receiving sleeve.

23. The end cap of claim 22, wherein said base has chamfered edges therearound.

24. The end cap of claim 23, wherein said first receiving sleeve and said second receiving sleeve are connected with each other.

25. The end cap of claim 24, wherein said first receiving sleeve and said second receiving sleeve are at a substantially right angle to each other.
